(19) United States
(12) Patent Application Publication
(10) Pub. No.: US 2007/0206747 A1
(43) Pub. Date: Sep. 6, 2007

(54) System and method for performing call screening

(76) Inventors: Carol Gruchala, Naperville, IL (US); Wayne Heinmiller, Elgin, IL (US); Dianna Tiliks, Palatine, IL (US); John W. Moss, Lake Zurich, IL (US); Jeffery Kufalk, Sussex, WI (US)

Correspondence Address: BRINKS HOFER GILSON & LIONE, P.O. BOX 10395, CHICAGO, IL, 60610, US

(21) Appl. No.: 11/365,960

(22) Filed: Mar. 1, 2006

(51) Int. Cl. H04M 15/06; H04M 1/56

(52) U.S. Cl. 379/142.01

(57) ABSTRACT

An efficient and effective system and method for screening calls is based upon user provided call screening preferences. The present embodiments utilize multiple types of information to effectively screen incoming and outgoing calls. The present embodiments also allow for the user to be notified of the calls that were screened.

### BACKGROUND

The present invention relates generally to telecommunications call processing and more particularly to controlling outgoing and incoming telecommunications.

Various types of telecommunications services exist for performing various types of call screening. However, one shortcoming that is common amongst these systems is that they utilize a single piece of information, such as an originating telephone, as the basis for screening calls. Because these systems utilize a single piece of information, they do not effectively screen all calls that can be made by a user. For example, by using only the dialed telephone number to screen outgoing calls, calls that are directed to the same entity, but initiated using other information, such as an internet protocol address for a voice over internet protocol call, are not screened. Similar shortcomings exist with respect to the screening of incoming telephone calls. Another shortcoming amongst these systems is that they fail to notify a user of the number of calls, types of calls, etc. that were screened. Yet another shortcoming is the lack of call control for wireless communication devices, such as cellular telephones. An improved system and method for screening calls that overcome these deficiencies are needed.

### BRIEF DESCRIPTION OF THE DRAWINGS

FIG. 1 is a block diagram of a system for screening calls.

FIG. 2 is more detailed block diagram of one embodiment of the system depicted in FIG. 1.

FIG. 3 is more detailed block diagram of a second embodiment of the system depicted in FIG. 1.

FIG. 4 is more detailed block diagram of a third embodiment of the system depicted in FIG. 1.

FIG. 5 is a flow diagram illustrating a method for establishing a call screening process in the system of FIGS. 1-4.

FIG. 6 is a flow diagram illustrating a call screening operation in the system of FIGS. 1-4.

FIG. 7 is a flow diagram illustrating an embodiment of screening of an outgoing call.

FIG. 8 is a flow diagram illustrating an embodiment of screening of an incoming call.

FIG. 9 illustrates options for provisioning outgoing and incoming call screening.

FIG. 10 is a block diagram of a general computer system.

### DETAILED DESCRIPTION OF THE DRAWINGS AND THE PRESENTLY PREFERRED EMBODIMENTS

By way of introduction, the embodiments described below include a method and system for effectively screening calls. In one embodiment, a user at a user station can provide information that can be used to provide comprehensive call screening for incoming and/or outgoing calls that are made to and/or from different communication devices and that are made using different types of communication networks. For example, a user at the user station can provide a list of traditional ten-digit telephone numbers that are used to provide call screening. The system can store those numbers so that incoming and/or outgoing calls can be effectively screened in accordance with screening rules established by the user. In one example, the numbers provided by the user can be used to determine which incoming and/or outgoing calls should be blocked. In another example, the numbers provided by the user can be used to determine which incoming and/or outgoing calls should be allowed. The system applies to both wireline and wireless calls in one or more communication systems. In addition, the system can cross reference those ten-digit telephone numbers to internet protocol numbers so that incoming calls that are directed to the called communication station and are made using a VoIP network can also be effectively screened in accordance with screening rules established by the user.

Ensuring that incoming and/or outgoing calls are effectively screened is particularly advantageous for a communication system in which more than one user has access to the communication devices. In a residential setting, the user may be a homeowner who has a babysitter or other person that is temporarily present in the user's home. In this example, the user may wish to prevent the babysitter from making certain types of calls, such as long distance telephone calls, and may also wish to prevent the babysitter from receiving calls from a certain telephone number. In another example, the user may be a parent who wishes to prevent certain outgoing calls during times when only the user's children have access to the communication device. In a business setting, the user may be a business owner or an administrator who wishes to prevent employees from making and/or receiving certain types of calls. The systems and methods described herein effectively satisfy all of these criteria.

In another embodiment, the systems and methods described herein enable the call screening information provided by the user to be applied to a number of different communication devices. In one example in a residential setting, the user's call screening preferences can be applied to all of the telephones associated with a family plan, including home-based analog telephones and cellular, personal communication system (PCS) or other wireless telephones. In this example, the user's (i.e. parent's) call screening preferences can be applied to a communication device, such as a cellular telephone, that may be in the possession of the user's child. In another example in a business setting, the user or administrator's call screening preferences can be applied to all of the communication devices associated with the business organization, including telephones and computers.

In a further embodiment, the systems and methods described herein further enable users at the user station to be notified of the number of calls, types of calls, etc. that have been screened. Again, this feature may be desirable in both residential and business settings, as the user or administrator may learn valuable information from being notified of the types of calls that were screened. For example, the user or administrator may learn who was attempting to make unauthorized outgoing calls, as well as the frequency of such attempted unauthorized calls. Also, the user or administrator may learn the source and frequency of unauthorized incoming calls, as well as the intended recipients of the unauthorized incoming calls.

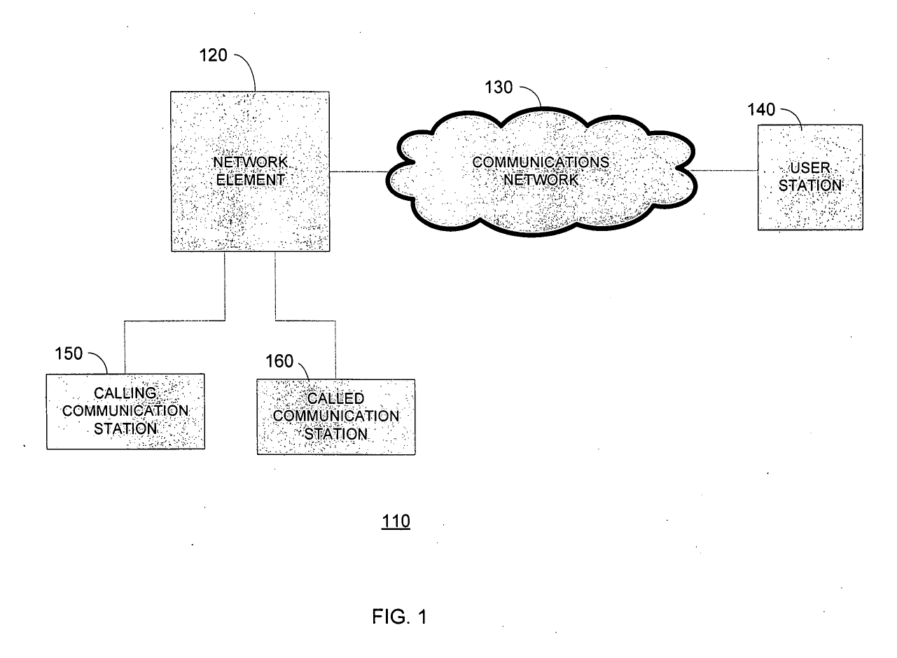

By way of example, FIG. 1 depicts a communications system 110. The system 110 comprises a network element 120 that is coupled with a user station 140 via a communication network 130. A calling communication station 150 and a called communication station 160 are also coupled with the network element 120. The phrase “coupled with,” as used herein, means coupled either directly or indirectly via one or more intervening elements.

The network element 120 preferably comprises one or more devices that cooperate to provide call screening services, and other services, as disclosed herein. Examples of the one or more devices include, but are not limited to, a service switching point, a service control point, a service node/intelligent peripheral, a database, a softswitch, a server, a media server, an application server, a trigger router, other advanced intelligent network (AIN) elements, other voice over internet protocol (VoIP) elements, and combinations thereof. In some applications, the network element 120 includes wireless communication equipment such as one or more base stations in radio communication with one or more radio telephones such as calling communication station 150 and called communication station 160. Preferably, the network element 120 can perform the functions described herein through the use of computer readable program code written in any suitable programming language and implemented utilizing any suitable operating system. Alternatively, the network element can perform the functions described herein through the use of hardware in the form of a hardwired computer, an integrated circuit, or a combination of hardware and computer readable program.

The communication network 130 preferably comprises a telecommunications network, such as the public switch telephone network (PSTN) or a cellular or PCS network, as known by those skilled in the art. Alternatively, the communication network can comprise a computer network, such as the Internet, or any other network that is adapted to transmit information.

The user station 140 preferably comprises a computer. Alternatively, the user station can comprise a communication device such as an analog telephone, a wireless communication device, a cellular communication device, a PCS device which accesses the network 130 using wireless protocols, or an device which accesses the network using the Integrated Services Digital Network (ISDN), or any other form of communication device adapted for use in the present embodiments.

The calling communication station 150 and the called communication station 160 preferably comprise a communication device, such as an analog telephone, a wireless communication device, a cellular communication device, a computer, a PCS device, an ISDN device, or any other form of communication device adapted for use in the present embodiments.

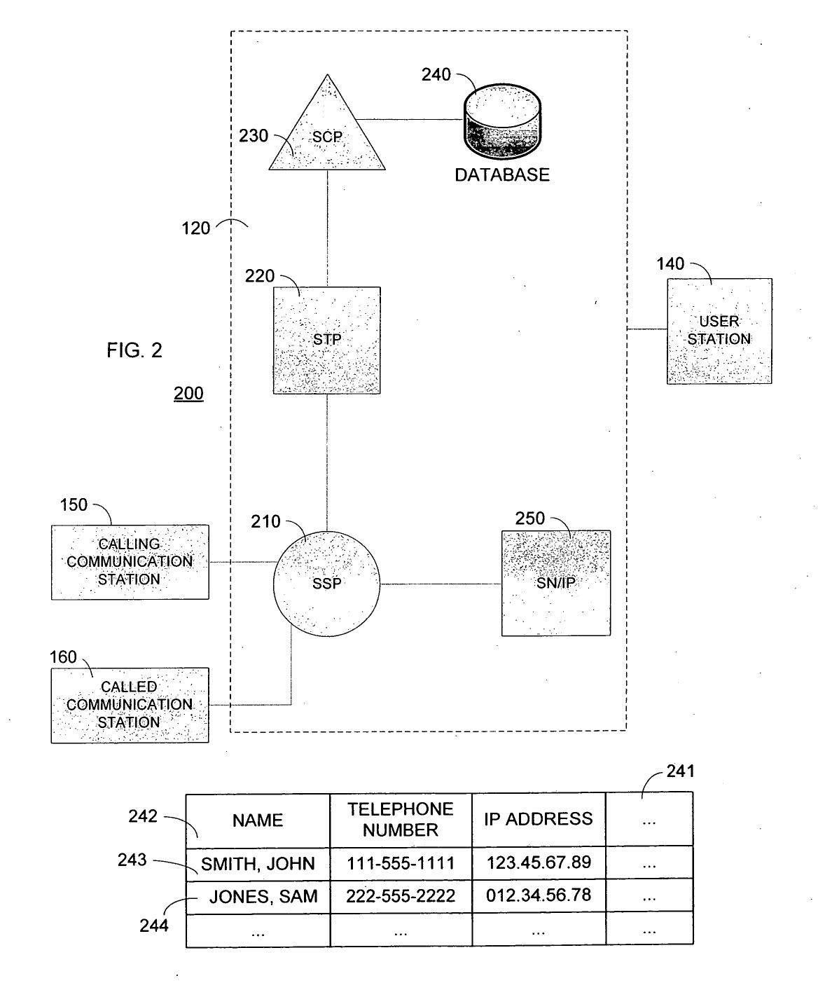

By way of further example, FIG. 2 depicts an embodiment of the system described above. The system 200 comprises a user station 140 that is coupled with and able to communicate with the components that make-up the network element 120. In this embodiment, the network element 120 comprises a service switching point (SSP) 210, a signal transfer point (STP) 220, a service control point (SCP) 230, a database 240, and a service node/intelligent peripheral 250. Other components can also be used in conjunction with these components to perform the functions described herein. This system can be implemented with intelligent network components, commonly referred to as advanced intelligent network (AIN) components, which can implement computer readable program code, and are commercially available from vendors such as Lucent Technologies or Telcordia Technologies. The AIN components preferably transmit information in accordance with a signaling protocol such as Signaling System 7 (SS7), internet protocols, or other such protocols as known by those skilled in the art. Vendors of AIN components typically have a programming language and operating platform as known by those skilled in the art. Alternatively, this system can be implemented using a UNIX platform, an NT server, or other suitable computer systems.

The SSP 210 is preferably coupled with the calling communication station 150 and the called communication station 160 and enables a calling party at calling telephone station 150 to place calls to the called communication station 160. In some instances, the calling communication station 150 and the called communication station 160 may be coupled with different SSPs, and in such an instance, the SSPs can route calls among one another in accordance with a signaling protocol such as Signaling System 7 (SS7), internet protocols, or other such protocols, as known by those skilled in the art. The SSP 210 is operative to generate triggers, such as termination attempt triggers (TATs) and originating triggers, and transmit queries in response to the triggers. For example, the SSP 210 can generate a query and transmit it to the SCP 230 via the STP 220 if a certain condition has been satisfied. The queries preferably enable the SSP 210 to request the return of certain information, such as call screening information, call identification information, call processing information, and call routing information, from the SCP 230. The SSP 210 can receive information from the SCP 230 and take further action based upon the information it receives.

The STP 220 preferably comprises a network switch that transmits signaling commands within the network. For example, the STP 220 can transmit queries and responses to queries between the SSP 210 and the SCP 230.

The SCP 230 preferably comprises an AIN element that can store information, receive queries, analyze information included within the queries, perform database or other searches, and transmit information to and receive information from other network elements. The SCP 230 preferably includes a set of predetermined logic rules that enable it to perform these and other actions. For example, the SCP 230 can receive a query that is generated by the SSP 210 and can access the database 240 to perform a database search or lookup. The SCP 230 can also transmit information to SSP 210. The SCP 230 is preferably implemented by a combination of hardware and software, and in an alternative embodiment, a suitable processor can be used in place of the SCP 230.

In an embodiment, the SCP 230 and/or the database 240 can store the table 241 shown in FIG. 2, which can be used to perform analyses that are used provide call screening. The table 241 preferably includes a plurality of line entries 242, 243, 244 that are used to associate multiple identifiers for a call source and/or a call destination. The line entry 244 is intended to denote that additional line entries can be included in the table 441 beyond what is shown in this example. Each line entry 242, 243 preferably includes a plurality of identifiers, which may include a standard 10 digit telephone number, an internet protocol address, a domain name, etc. Further, for each subscriber entry (each line of the table 241), there may be many entries of several different types. For example, one subscriber may have multiple wireline telephones for which he has call screening in place, multiple wireless telephones with call screening, etc. Still further, each line entry 244 may include data defining the call screening to be put in place, such dates and times when calls should be screened. The SCP 230 can utilize the table 241 to retrieve the multiple identifiers for a call source and/or call destination based upon one identifier for a call source or call destination. The multiple identifiers enable all calls to and from a source and a destination identified by the user to be effectively screened.

The database 240 preferably comprises a traditional database, as known to those skilled in the art. Alternatively, the database 240 can comprise a CNAM or ENUM database, as known by those skilled in the art. The database 240 can also include predetermined logic rules that enable it to perform analyses and to perform other actions such as database searches and lookups, and may also perform such analyses, searches, and lookups in response to requests for information that can be transmitted from other network elements, such as the SCP 230. The database 240 may be divided in any convenient way, including among separate databases or on different storage media, kept locally or remotely.

The service node/intelligent peripheral (SN/IP) 250 preferably comprises a network element that stores call control information and performs call related functions. SN/IP 250 can receive calls, performs searches, analyzes data, and transmit information to the calling communication station 150 and the called communication station 160 SN/IP 250 can also include a text to speech module that performs text to speech conversions to produce an audible representation of textual information or data. Such modules and conversions are well known by those skilled in the art. SN/IP 250 can also record information, such as audible messages transmitted from the calling communication station 150 and the called communication station 160 and can transmit audible messages to the calling communication station 150 and the called communication station 160.

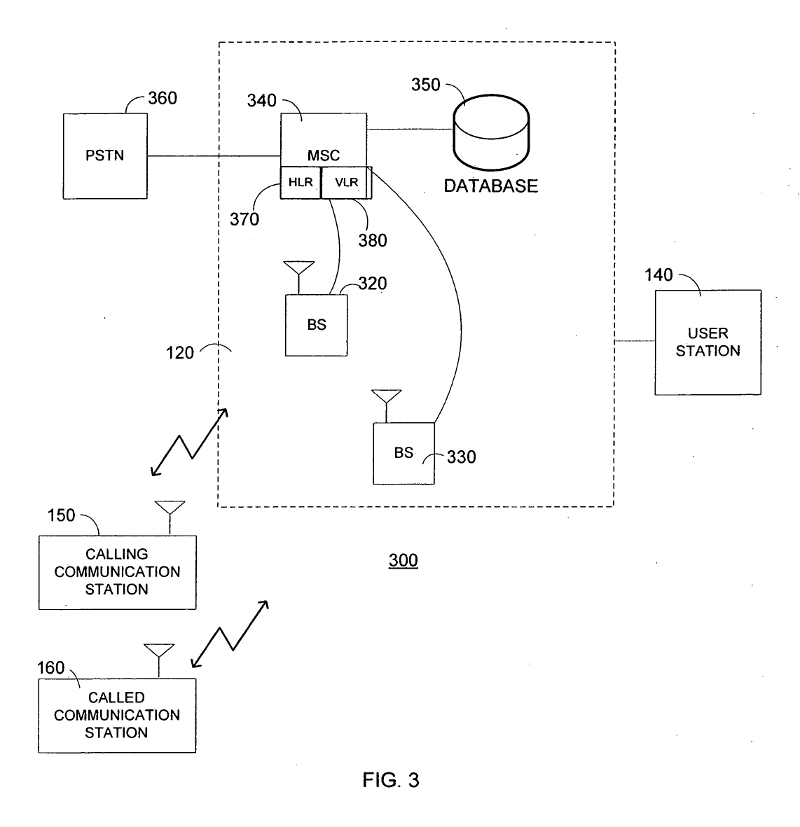

By way of further example, FIG. 3 depicts a second embodiment of the system 110 described above. FIG. 3 shows system 300 which implements a wireless communication system. The system 300 comprises a user station 140 that is coupled with and able to communicate with the components that make-up the network element 120. In this embodiment, the network element 120 comprises a plurality of base stations 320, 330, a mobile switching center (MSC) 340 and a database 350. Other components can also be used in conjunction with these components to perform the functions described herein.

The system 300 implements a wireless communication system of any suitable type. The system 300 should not be limited by particular technology but can be extended to include any type of cellular radio system, personal communication system (PCS), trunked radio network, satellite radio system or other radio communication service. Moreover, the system 300 may include combinations of these, or networks of networks or may separately include combinations of wireless networks combined with wire line networks. Examples of such wireless networks include cellular and PCT systems operating according to the Code Division, Multiple Access (CDMA) standard, Time Division, Multiple Access (TDMA) standard, the Global System for Mobile communication (GSM) standard, third generation (3G) radio standards, and others systems now known or to be developed.

In the embodiment of FIG. 3, the calling communication station 150 and the called communication station 160 include mobile radio equipment which can establish a radio communication link with one or more base stations 320, 330. The radio communication link is established according to the radio protocol or air interface standard which defines operation in the network. The calling communication station 150 and the called communication station 160 can include radio telephones designed for voice and/or data communication with the network, or can include devices providing greater functionality, including a personal digital assistant (PDA) or personal computer (PC). The users of the mobile stations are referred to as subscribers, who subscribe to telecommunications service with the system 300.

Each base station 320, 330 provides radio communication service to a geographical service area adjacent to the base station. Radio communication is according to one or more radio protocols which define signalling and information transfer for the radio links between the base stations 320, 330 and mobile stations such as the calling communication station 150 and the called communication station 160. Further, the base stations 320, 330 provide handover of communications with a respective mobile station from one base station to another base station, permitting mobility of the mobile stations.

The base stations 320, 330 are controlled by the MSC 340. The MSC 340 operates as a switch for call processing and control. The MSC 340 is in wire line communication with the base stations 320, 330 to monitor and control calls between the respective base stations and mobile stations in the network. During a handover, the MSC 340 controls the identification of a suitable handover candidate base station, initiation of communication with the candidate base station and termination of communication with the current base station. Moreover, the MSC 340 controls communication between a base station and the public switched telephone network (PSTN) 360. Thus, a mobile station such as the calling communication station 150 can place a call outside the system 300, for example, to a communication station in another wireless network or to a communication station in a wire line network such as the system 200 of FIG. 2. Similarly, the called communication station 160 can receive a call from outside the system 300, such as from a communication station of the system 200. In a typical embodiment, the system 300 will include a plurality of MSCs such as MSC 340. The plurality of MSCs communicate information about calls and subscribers in the system.

The MSC 340 operates in conjunction with a database 350 which stores information about the communication stations 320, 330, call processing data and instructions, account information and other information. Thus, when a call is initiated, a base station contacts the MSC 340 which obtains call processing and account information from the database 350 and returns the necessary information to the base station. When a handover becomes necessary, the MSC 340 obtains the necessary information about candidate base stations and controls the handover process using information retrieved from the database 350. The database 350 may be maintained as a single database, as a plurality of memory devices, or in any convenient form.

The MSC 340 also includes a home location register (HLR) 370 and a visiting location register (VLR) 380. The home location register is part of the main database of permanent subscriber information for the system 300. The HLR is a component of a CDMA system, a TDMA system, and a GSM system, and a similar component may be included in other present and future systems. The HLR 370 is maintained by the subscriber's home carrier (or the network operator where the user initiated the call). The HLR contains pertinent user information, including address, account status, and preferences. The HLR interacts with the MSC 340, which is a switch used for call control and processing. As noted, the MSC 340 also serves as a point-of-access to the PSTN.

The Visiting Location Register (VLR) 380 maintains temporary user information (such as current location) to manage requests from subscribers who are out of the area covered by their home system 300. The VLR 380 is updated with information from the HLR 370.

When a user initiates a call, switching equipment including the MSC 340 determines whether or not the call is coming from the mobile unit's home area. If the user is out of the home area, the area VLR 380 sends out a request for information required to process the call. An MSC queries the HLR identified by the call for information, which it relays to the appropriate MSC, which in turn relays it to the VLR 380. The VLR 380 sends routing information back to the MSC which allows it to find the station where the call originated, and, finally, the mobile unit to connect. In one embodiment, communications between the elements are based on Signaling System 7 protocols and signaling.

For controlling screening of calls, a table similar to the table of FIG. 2 may be stored in the MSC 340 or at any other convenient location in the network. Prior to completion of a call, contents of the table are retrieved to determine if the call should be screened.

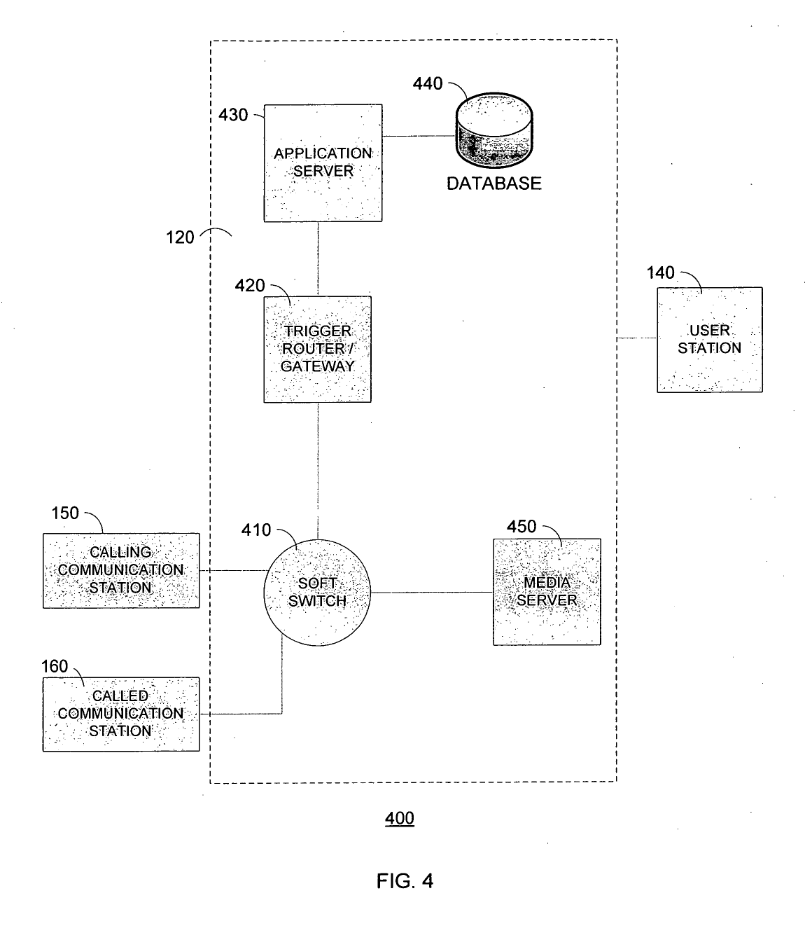

Referring now to FIG. 4, an alternative embodiment of the system of FIG. 1 is shown that can be used in conjunction with voice over internet protocol (VoIP) communications. FIG. 4 shows a system 400 which comprises a user station 140 that is coupled with and able to communicate with the components that make-up the network element 120 in this embodiment. In this embodiment, the network element 120 comprises a softswitch 410, a trigger router/gateway 420, an application server 430, a database 440, and a media server 450. Other components can also be used in conjunction with these components to perform the functions described herein. These network components preferably transmit information in accordance with a protocol such as Session Initiation Protocol (SIP), internet protocols, or other such protocols as known by those skilled in the art.

The softswitch 410 is preferably coupled with the calling communication station 150 and the called communication station 160 and enables a calling party at calling telephone station 150 to place calls to the called communication station 160. In this embodiment, the softswitch 410 functions in largely the same manner as the SSP 210 described above. The softswitch is operative to generate triggers, such as termination attempt triggers (TATs) and originating triggers, and to transmit queries in response to the triggers. For example, the softswitch 410 can generate a query and transmit it to the application server 430 via the trigger router 420 if a certain condition has been satisfied. The queries preferably enable the softswitch 410 to request the return of certain information, such as call screening information, call identification information, call processing information, and call routing information, from the application server 430. The softswitch 410 can receive information from the application server 430 and take further action based upon the information.

The trigger router/gateway 420 preferably comprises a network switch that transmits signaling commands, such as triggers and queries, within the network. In this embodiment, trigger router 420 functions in largely the same manner as the STP 220 described above.

The application server 430 preferably comprises a network element that can store information, receive queries, analyze information included within the queries, perform database or other searches, and transmit information to and receive information from other network elements. In this embodiment, the application server 430 functions in largely the same manner as the SCP 230. The application server 430 preferably includes a set of predetermined logic rules that enable it to perform these and other actions. For example, the application server 430 can receive a query that is generated by the softswitch 410 and can access the database 440 to perform a database search or lookup. The application server 430 can also transmit information to softswitch 410. In one embodiment, the application server 430 and/or the database 440 can store the table 241 shown in FIG. 2 as discussed above. In another embodiment, an SCP such as SCP 230 of FIG. 2 in another telecommunications network is accessed for call routing information, rather than or in addition to the application server 430.

The media server 450 preferably comprises a network element that stores call control information and performs call related functions. In this embodiment, the media server 450 functions largely in the same manner as the SN/IP 250 described above in conjunction with FIG. 2. The media server can receive calls, performs searches, analyzes data, and transmit information to the calling communication station 150 and the called communication station 160. The media server 450 can also include a text to speech module that performs text to speech conversions to produce an audible representation of textual information or data. Such modules and conversions are well known by those skilled in the art. The media server 450 can also record information, such as audible messages transmitted from the calling communication station 150 and the called communication station 160 and can transmit audible messages to the calling communication station 150 and the called communication station 160.

The systems depicted in FIGS. 1, 2, 3 and 4 can be utilized to implement the following method. For purposes of illustration, assume that a user at user station 140 has determined that he or she would like to have a form of call screening implemented for outgoing calls on a certain day of the week and during a certain period of time. The user has decided that the user would like to prevent outgoing calls from being made to a certain destination, i.e. a telephone number in this example, and the user can access the network element 120 and provide information, including an identifier and date and time information for the desired screening, that signifies the user's call screening preferences. The user can transmit a telephone number to which he or she would like to prevent outgoing telephone calls. The user can further transmit identifying information for one or more telephone devices to which this call screening setting should apply. The identifying information may specify a wire line telephone, a wireless telephone, a VoIP telephone or combinations of these or other devices accessible by a telecommunications network. The telephone number or numbers and other identifying information provided by the user is received by the system. The telephone number and other information can then be stored along with an indicator that signifies that calls to the telephone number from the specified originating device, on the specified date and during the specified time, should be screened. The identifier, i.e. telephone number in this example, is also used to determine a second identifier, an IP addresses in this example, which corresponds to the telephone number. The second identifier is also stored along with the first identifier and the call screening indicator. In addition, call screening logic can be created, stored, and associated with the identifiers so that the systems disclosed herein can perform the call screening functions disclosed herein.

In the case of the systems of FIGS. 2 and 4, when an outgoing call is initiated by a caller at the calling communication station 150, that call is received by the SSP 210 or the softswitch 310 and a trigger can be activated that causes a query to be generated by the SSP 210 or softswitch 310 and transmitted to the SCP 230 or application server 330. The query can include an identifier for the intended destination of the outgoing call, such as a telephone number or an IP address. The SCP 230 or application server 330 can receive the query and determine an identifier for the intended destination of the call based upon the contents of the query. The SCP 230 or application server 330 can also determine, based upon the current date and time and by accessing stored information which also defines, for examples, calling communication devices for which the call screening feature should apply, whether call screening should be performed for outgoing calls made from the calling communication station 150. If call screening should be performed, the SCP 230 or application server 330 can compare information associated with the intended destination of the call, such as a telephone number for a traditional telephone call and an IP address for a VoIP call, to the identifiers provided by the user for call screening to determine whether one of the identifiers matches the identifier for the destination. If one of the identifiers matches the identifier for the destination, the call can be screened. Thus, calls to the identifier or identifiers provided by the user are screened while all other calls are not. In the preferred embodiment, a common screening list is used for all devices associated with the subscriber to the service. The call screening can be established for all calls for all devices (wireline devices, wireless devices, etc.) or for some of the devices, based on the telephone number assigned to the device or devices. Or, call screening can be established according to a schedule by day of the week, time of day, etc., for respective devices.

In an alternative embodiment, the identifier provided by the user can be used in call screening such that only calls to that identifier are allowed to go through. Calls to identifiers other than those provided by the user are screened. In this example, an in the other examples herein, screening the call may be accomplished by any suitable method which prevents completion of the call. For example, before attempting to terminate a call from a serving SSP to the screened called communication station, an announcement may be played to the calling party and the call ended. Alternatively, the call may be left to ring, from the perspective of the calling party, without actually ringing the called communication station and without providing an announcement. In the case of a wireless called communication station, the MSC may screen the call by refusing to locate the called wireless device in the network. Alternatively, the call may be forwarded from the MSC to the base station serving the area where the wireless device is located, with the base station then refusing to provide a paging signal to the wireless device, thereby screening the call.

In the wireless embodiment of FIG. 3, when an outgoing call is initiated by a caller at the calling communication station 150, the calling communication station 150 sends a request to a current base station 320 with which the calling communication station 150 is currently registered. The request includes identification information for the calling communication station 150 and an identifier for the intended destination of the call. A query is passed from the base station 320 to the MSC 340. The MSC 340 retrieves the contents of the HLR 370 for the caller and confirms that the caller is a valid subscriber. If so, the call is processed to either another subscriber within the system 300, such as communication station 160, or to a called party outside the system 300 using the PSTN 360.

Based upon the current date and time and by accessing stored information of the HLR 370 or VHLR 380, the MSC 340 can also determine whether call screening should be performed for outgoing calls made from the calling communication station 150. If call screening should be performed, MSC 340 can compare information associated with the intended destination of the call, such as a telephone number, to the identifiers provided by the user for call screening to determine whether one of the identifiers matches the identifier for the destination. If one of the identifiers matches the identifier for the destination, the call can be screened. Thus, calls to the identifier or identifiers provided by the user are screened while all other calls are not.

In the wireless environment of FIG. 3, the HLR 370 needs to notify VHLRs in other areas that the subscriber associated with the calling communication station 150 has provided identifiers to be screened and the HLR 370 needs to authenticate each call prior to completing the call. Depending on the wireless service provider, the VHLR may be able to authenticate the call itself without contacting the HLR for authentication. This is generally true if the VHLR and HLR are maintained by the same service provider, i.e., in the situation where the calling communication station 150 is not roaming. Moreover, some carriers have fraud screening capabilities to deal with stolen cellular phones. In such a case, the call screening service must coordinate with the fraud screening service so that the fraud screen occurs first, followed by the call screening service.

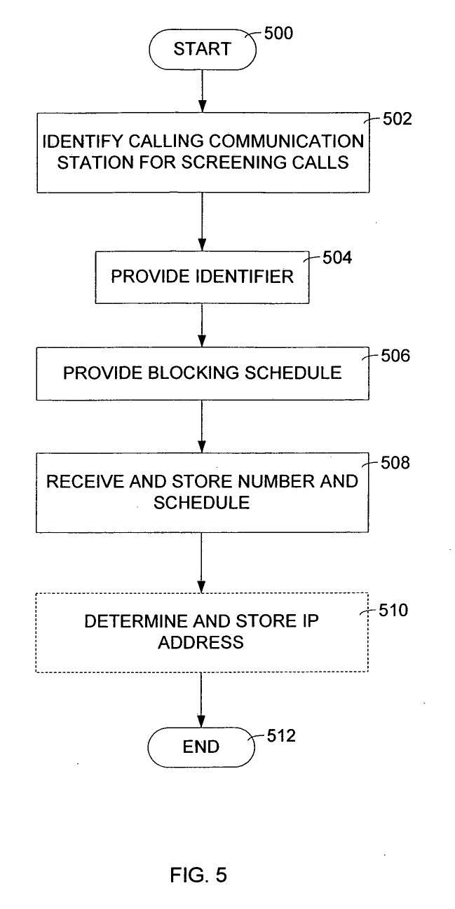

The systems depicted in FIGS. 1, 2, 3 and 4 can also be utilized to implement the following method, illustrated in FIG. 5 and beginning at block 500. For purposes of illustration, assume that a user at user station 140 has determined, block 502, that he or she would like to have a form of call screening implemented for outgoing calls on a certain day of the week and during a certain period of time. The user has decided that they would like to prevent outgoing calls made from one or more certain communication stations, i.e. one or more telephone number in this example. In the preferred embodiment, the user can access the network element 120 and provide the telephone number or numbers from which they would like to prevent outgoing telephone calls, block 504. The network element 120 in one embodiment presents a web page on which can be entered the telephone numbers for which the blocking service should be initiated. Here, the term telephone number refers to a directory number for wire line telephones and wireless telephones. For wireless telephones, the telephone number may also or alternatively be the mobile identification numbers which uniquely identifies wireless devices. For VoIP devices, the telephone number may also or alternatively be the network addresses of the devices. The web page preferably includes a fill-in form with places for the user to enter the telephone numbers of one or more devices to be subject to the call screening service. The specified devices may be wireline or wireless devices, or any combination. The web page further preferably provides places for entry of additional call screening details such as time of day and day of week when the call screening service should be activated. Upon completion of the web page form, the user clicks a link and the web page is communicated from the network element to a network component such as a web server. The web server processes the call screening data and updates, for example, the SCP database where the call screening subscription information is stored.

As noted, the user can transmit other call screening information, including an identifier and date and time information for the desired screening schedule that signifies the user's call screening preferences, block 506. The telephone number provided by the user is received by the system, block 508. The telephone number can then be stored along with an indicator that signifies that calls from the telephone number on the specified date and during the specified time should be screened. The identifier, i.e., a telephone number in this example, in some embodiments is also used to determine a second identifier, an IP address for a VoIP device or a mobile identification number in this example, which corresponds to the telephone number. This is indicated in FIG. 5 by block 510, which is shown in dashed line to indicate this is an optional step. The second identifier is also stored along with the first identifier and the call screening indicator.

At block 512, it is determined if there are more numbers to add to the call screening information. For example, the user may wish to have calls to a specified directory number screened from both a land line telephone and calls from a wireless telephone. In one example, a parent wishes to prevent a child making calls to a specified number from both the home land line telephone and from the child's personal wireless phone. If there are more originating numbers to add to the call screening information at block 512, at block 514, the user is prompted to enter the next number. The method loops through blocks 504, 506, 508 and 510 until the user indicates that all numbers from which outgoing calls should be blocked have been added. The method ends at block 516.

Other alternatives for entering the call screening information may be substituted or offered for the convenience of the subscriber. For example, the subscriber to the service may access the call screening service using a personal computer over the internet and be presented with one or more web pages on which the call screening information may be entered. In one example, on a first page, the subscriber is presented with a set of data entry boxes for specifying the originating numbers from which calls should be screened. The originating numbers may be land line telephone (directory) numbers, cellular telephone numbers (or mobile identification numbers) or VoIP telephone numbers or network addresses. On the same page or a subsequent page, the user may be provided with a set of data entry boxes for entering the directory numbers to which calls from the previously-specified originating number should be blocked. On yet a subsequent page or pages, the user may be provided with data entry boxes for specifying a blocking schedule. Other information may be collected as well.

In another alternative, the user may be provided with access to a dial up number for specifying the call screening information, including the originating numbers to which the service is to be applied and the numbers to be screened. The user interaction may be by engaging a human operator verbally to specify the call screening information or by entering keypresses on a telephone. Other method for specifying the call screening information may be provided as well.

These arrangements are particularly useful where the telephone devices to which the subscriber wishes to apply the call screening service are provided by a single service provider. For example, one service provider may provide wire line telephone service over and AIN network and the PSTN and wireless service over a cellular telephone network and VoIP service over the internet. The subscriber may subscribe to service on one, two or three of these systems but may have a single account for recording accounting information, call screening information, and other data. The disclosed system and method may be used to set the account for a subscriber to specify call screening for communication devices operable on all networks.

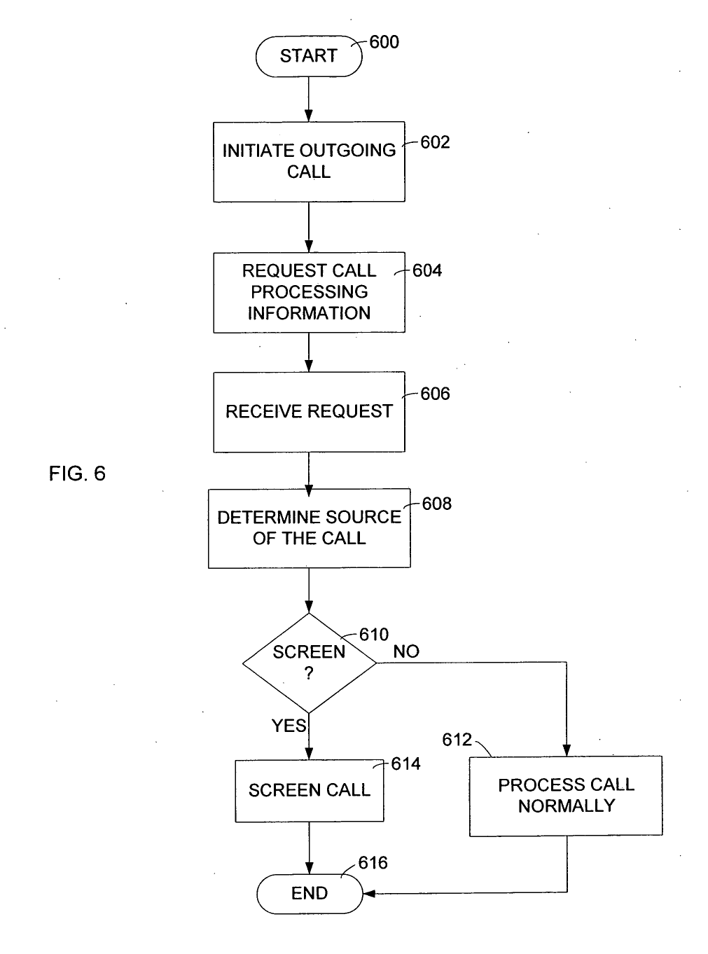

A method of implementing a call screening process may be described in conjunction with FIG. 6. The method begins at block 600. A calling party at the calling communication station initiates an outgoing call, block 602. In the context of FIGS. 2 and 4, when an outgoing call from the calling communication station 150 is received at the SSP 210 or softswitch 410, a trigger can be activated that causes a query to be generated by the SSP 210 or softswitch 410 and transmitted to the SCP 230 or application server 430, block 604. The query can include an identifier for the source of the outgoing call and the destination of the outgoing call, such as a telephone number or an IP address. The SCP 230 or application server 430 can receive the query, block 606, and determine an identifier for the source of the call based upon the contents of the query. For example, a trigger generated by the SSP 210 and passed to the SCP 230 includes the directory number of the calling number.

The SCP 230 or application server 430 can also determine, based upon the current date and time and by accessing stored information, whether call screening should be performed for outgoing calls made from the calling communication station 150, block 610. For example, the SCP can retrieve information from the SCP database 240 and determine if call screening has been specified by the subscriber, if a schedule has been specified and if the current call should be screened.

If call screening should not be performed, the call is processed in the normal manner, block 612. For example, the SCP 230 returns call routing information to the SSP 210 to instruct the SSP 210 where to route the call for the called communication station. The proceeds without further interruption.

If call screening should be performed, block 614, the SCP 230 or application server 430 can compare information associated with the source of the call, such as a telephone number for a traditional telephone call and an IP address for a VoIP call, to the identifiers provided by the user for call screening to determine whether one of the identifiers matches the identifier for the source. If one of the identifiers matches the identifier for the destination, the call can be screened. Thus, calls from the identifier or identifiers provided by the user are screened while all other calls are not. If the call is screened, the system can provide a message to the caller advising of the fact. For example, the call processing logic executed by the SCP 230 may direct the SN/IP 2504 (FIG. 2) to play a standard message to the caller explaining that the attempted call has been blocked. The method of FIG. 6 ends at block 616.

In an alternative embodiment, the identifier provided by the user can be used in call screening such that only calls from that identifier are allowed to go through. Calls from identifiers other than that provided by the user are screened.

In the wireless context of FIG. 3, an outgoing call is initiated, block 602, when an outgoing call from the calling communication station 150 is received at the base station 320. The base station 320 contacts the MSC 340 for call routing information, block 604. The MSC 340 receives the request, block 606, and provides call routing information in response. The MSC 340 determines the subscriber unit, calling communication station 150, based on the information contained in the request, block 608. The MSC 340 retrieves the contents of the HLR 370 to determine pertinent user information for the calling communication station 150, including call screening status if any and a call screening schedule, if any, block 610. If no call screening is to occur, at block 612, the call is processed normally. If call screening should occur, though, at block 614, the call is screened or blocked by the MSC 340.

In the examples described above, the information that is transmitted by the user is preferably transmitted using a computer and a computer network. In these embodiments, the information can be transmitted as data using a communication protocol, such as TCP/IP. In alternative embodiments, the information can be transmitted by the user using a telephone. In these embodiments, the information can be transmitted using DTMF tones. In further alternative embodiments, the information can be transmitted using the other communication devices described herein. After the information provided by the user has been used to store the identifiers, call screening logic, etc., as described above, the user can activate and deactivate the call screening by providing control signals. In one embodiment, the user can utilize a computer to access a GUI provided via website or some other computer platform to activate and deactivate the call screening. In another embodiment, the user can utilize a telephone to provide DTMF tones to activate or deactivate the call screening. By way of example, the user could utilize a * command, such as *96 to activate or deactivate the call screening. In further alternative embodiments, the call screening can be activated and deactivated using the other communication devices described herein.

In the examples described above, as an alternative to automatically screening calls if a certain precondition is met, the systems can inform the caller that the call that they are attempting to make is subject to screening and can provide the caller with an opportunity to enter an override code, such as password or personal identification number (PIN), which would allow the call to avoid screening. The password or PIN can be selected by the user or administrator and can be used as a security measure such that those that know the password or PIN will be allowed to make calls that those who do not know the password or PIN are not allowed to make.

The systems disclosed and described herein can also inform the user of calls that were screened. In one embodiment, the system can keep track of the calls that were screened and can send an email to the user at the user station information the user of the calls that were screened. The email can include general information, such as the number of calls that were screened, and can also include more specific information, such as the identifiers for the outgoing or incoming calls that were screened, as well as the date and time of the screening. In an alternative embodiment, the system and provide information about the calls that were screened via a webpage that can be accessed by the user at the user station. In further alternative embodiments, the user can be notified of the screened calls via Short Message Service notification, text messaging, or by regular mail.

The act of receiving information from user at the user station can be facilitated through the use of a graphical user interface (GUI) through which the user can provide the information that specifies their screening preferences. The GUI can include fields in which the user can enter identifiers for call sources and/or destinations for which the user would like call screening. The GUI can also include fields that allow the user to enter a day of the year, day of the week, and/or time of day for the call screening to be active.

In one embodiment, the act of screening a call can comprise canceling the call by not allowing the incoming or outgoing call to be completed. In another embodiment, the act of screening a call can comprise routing an incoming call to voicemail. In yet another embodiment, the act of screening a call can comprise sending a message to the calling party that advises them that the call cannot be complete because of the user's call screening preferences.

The calling party can initiate the method by dialing a telephone number. Alternatively, the calling party can initiate the call using a computer. One such way is by activating a push or click to talk button, which are commonly available on websites.

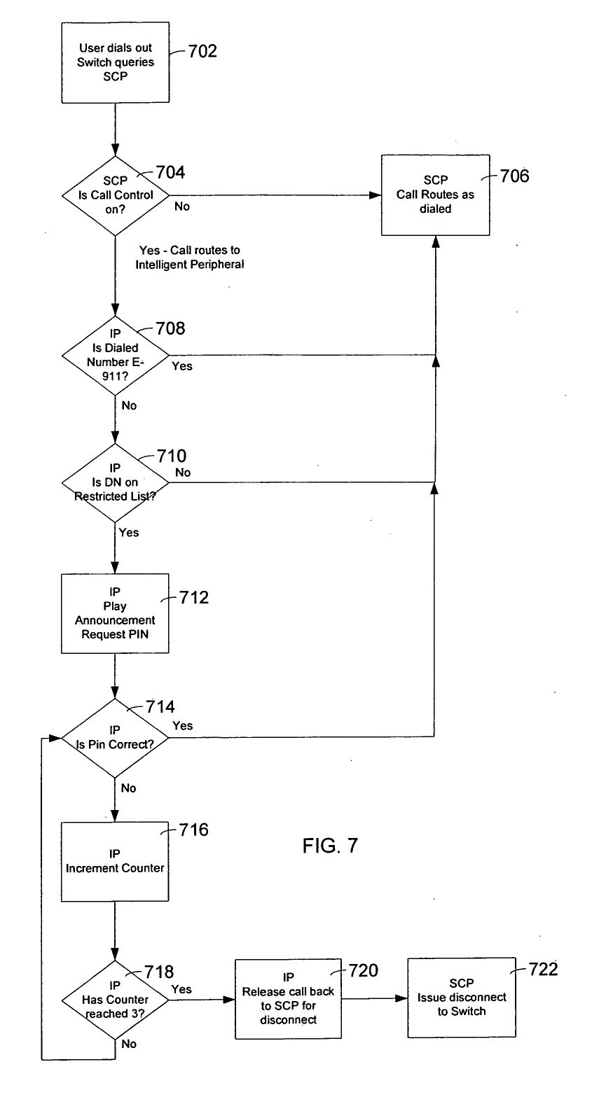

FIG. 7 is a flow diagram illustrating an embodiment of screening of an outgoing call. This example illustrates enhanced call control in an AIN environment such as is illustrated in FIG. 2, along with AIN platform interactions. Once provisioned in accordance with the method illustrated in FIG. 7, the AIN SN/IP will store a database with which call routing decisions can be made.

At block 702, the calling party dials out from a calling communication station. A called directory number (DN) is associated with the call. The call is received at an SSP associated with the calling communication station. The SSP routes a query to the SCP for call processing instructions. At block 704, the SCP determines if call control is activated for the calling communication station. Call control includes call blocking features including, in some embodiments, blocking outgoing calls according to the called number and blocking incoming calls according to the calling number, and blocking calls according to a schedule by time of day, day of week, etc. The SCP retrieves a call control file from the SCP database or any other suitable data storage location in the network. The call control file stores data defining call control options as specified for the calling communication station. If the SCP determined that call control is not activated, control proceeds to block 706 and the SCP routes the call as dialed.

In this exemplary embodiment, the SN/IP is used to interact with the calling party and called party. In other embodiments, the SSP or end office switch which serves the called communication station may be used to interact with the calling party or called party. If at block 704, call control is activated, the SCP retains control of the call or routes the call to an intelligent peripheral, referred to as an IP or SN/IP. At block 708, the SN/IP or SCP determines if the called number is an emergency number, such as 911. If so, the SN/IP re-routes the call back to the SCP or SCP retains call control and the call control is overridden. At block 706, the SCP routes the call normally.

Otherwise, at block 710, the SN/IP or SCP determines if the called DN is on a restricted list. The restricted list is established by the subscriber to the call control service, for example, using an interactive voice response (IVR) system or by using a world wide web browser to access a server which is in data communication with the telecommunications network including the SCP, SSP and SN/IP. The restricted list defines called directory numbers to which calls from the calling communication station will be blocked by the call screening service. Alternatively, or in addition, the restricted list may store directory numbers to which call from the calling communication station are to be completed, with non-listed numbers being blocked by the service. The SN/IP or SCP compares the called DN with the contents of the restricted list. If the called DN is not on the restricted list, control proceeds to block 706 and the SCP routes the call normally. Otherwise, if the called DN is on the restricted list, control proceeds to block 712.

At block 712, the calling party at the calling communication station is given a chance to override the call screening service. The SN/IP or SSP plays an announcement to the calling party inviting the calling party to enter a personal identification number (PIN) or other override data. The PIN may be established by the subscriber to the call screening service in the same way the restricted list was established. The SN/IP retrieves the PIN from storage, for example, at the SN/IP itself or at the SCP in the SCP database. The SN/IP or SSP then waits for key press entry from the calling communication station.

At block 714, if the calling party enters a PIN which matched the retrieved PIN, control proceeds to block 706, the call screening service is overridden and the SCP routes the call normally. On the other hand, if the an incorrect PIN is entered or if no PIN is entered and the SN/IP or SSP times out waiting for key press entry, control proceeds to block 716 where a counter is incremented. Preferably, a message is played explaining that the entered PIN is incorrect and inviting the calling party to re-enter a PIN. At block 718, the counter value is compared with a threshold value such as 3. The calling party is given 3 opportunities to enter the correct PIN, control remaining in a loop including blocks 714, 716 and 718. If the test of block 718 fails, control proceeds to block 720 where the SN/IP or SSP releases the call back to the SCP which then disconnects the call. At block 722, the SCP issues a disconnect command to the SSP associated with the calling communication station, disconnecting the call. Prior to disconnection. a message may be played to the calling party advising of the call termination.

In some embodiments, some of the operations illustrated in exemplary FIG. 7 may be omitted. In other embodiments, some additional operations may be added or substituted, or the order illustrated in FIG. 7 may be rearranged, depending on particular system requirements and capabilities.

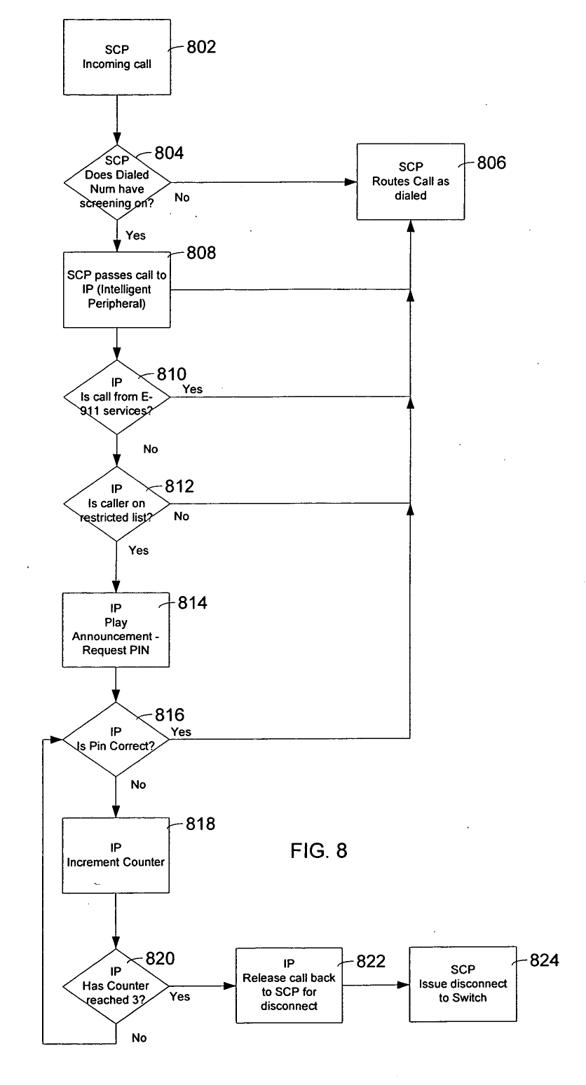

FIG. 8 is a flow diagram illustrating an embodiment of screening of an incoming call. FIG. 8 shows an example of processing an incoming call by a call control service, along with associated interactions of the AIN platform. Once provisioned, a database stores information with which routing decisions can be made. The database can be stored, for example, at the SCP or at an SN/IP in the communications network. According to the service, incoming calls from calling directory numbers (DN) which are on a restricted list are blocked from completing to the called communication station. Alternatively, only calls from calling DNs are completed; all others are screened. In one embodiment, callers are prompted for a personal identification number (PIN) or other bypass data to allow override of the call control service.

At block 802, the SCP processes the incoming call. In some embodiments, the call is routed to the switch or SSP associated with the called communication station, based on the called DN. The SSP which receives the call encounters a terminating attempt trigger and responds to the received call by generating a terminating attempt query message. The query message is passed by the SSP to the SCP to obtain call routing instructions. The SCP retrieves information from the SCP database along with the screening list, if any, associated with the called DN. At block 804, the SCP determines if the call control service is active for the called DN. If not, at block 806, the SCP routes the call normally.

Otherwise, at block 808, the SCP forwards the call to a SN/IP or retains the call for further processing. At block 810, the SN/IP or SCP determines if the call is from an emergency number, such as 911, or from another calling communication station which should never be blocked. If so, call proceeds to block 806 and the SCP routes the call normally. Otherwise, at block 812, the SN/IP or SCP determines if the call is on the restricted list. That is, the SN/IP or SCP compares the called DN with data of the restricted list to identify a match. If there is no match, control proceeds to block 806 and the SCP routes the call normally. Otherwise, if there is a match at block 814, the SN/IP or SSP plays an announcement to the calling party advising of the service and inviting the calling party to enter a PIN or other override data. At block 816, the SN/IP or SCP determines if the received PIN is correct. If so, control proceeds to block 806 and the SCP routes the call normally.

If at block 816, the entered PIN does not match the stored value, at block 818 a counter is incremented. The counter is used to count the number of times the calling party enters an incorrect PIN value. Control remains in a loop including blocks 816, 818, 820 until the counter exceeds a threshold value, such as 3, or until the correct PIN is entered. The caller may be prompted to enter the correct PIN. If the counter exceeds the threshold value, at block 822, the SN/IP releases the call back to the SCP to disconnect the call. At block 824, the SCP issues a disconnect to the switch or SSP. A disconnect message may be played to the calling party advising that the call is blocked.

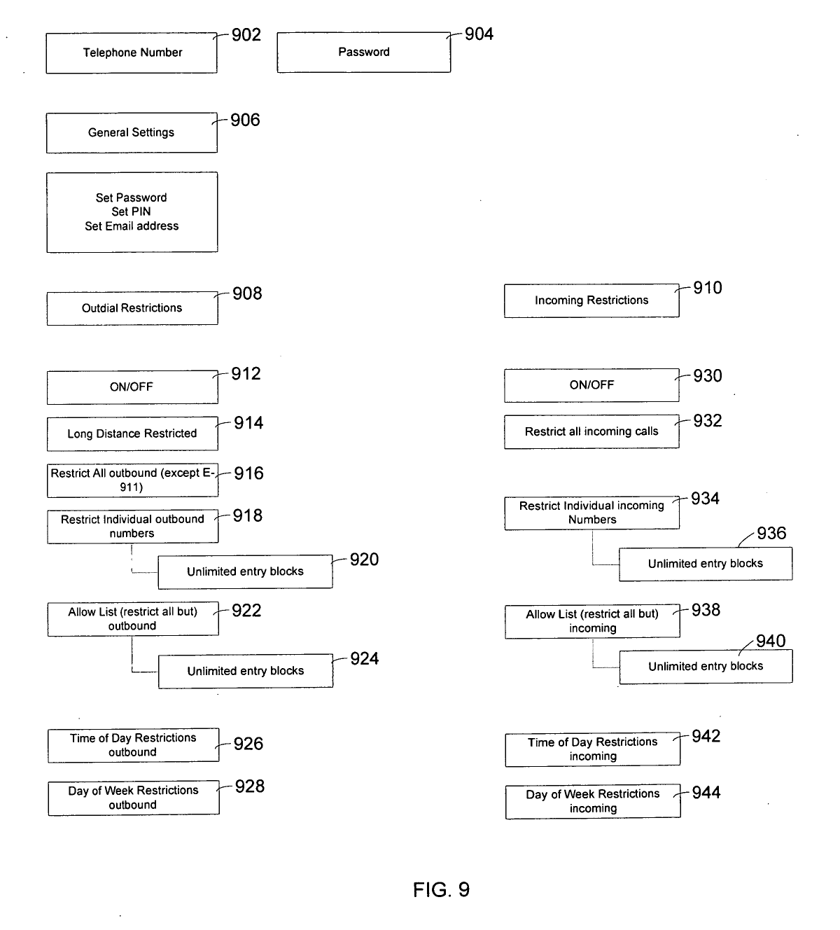

FIG. 9 illustrates options for provisioning outgoing and incoming call screening. Provisioning is preferably achieved by a Secure Sockets Layer (SSL) secured website. Web-based provisioning is desirable because it allows the subscriber to manually set up and update the service according to his particular requirements, without need for intercession of a customer service representative. Also, web based provisioning provides visual confirmation of account settings. For example, a subscriber may use a web page to select the service and its features, and to specify details such as the directory number to which the service is applied, a password for secure access and the PIN for service override. The user use a single list of telephone numbers to specify devices on all services (wireline and wireless) which should be subject to the call screening service. The subscriber can list phone numbers or enter them on the web page. When the web page is approved by the subscriber, he can transmit over a network such as the internet to a server which is in data communication with the network (AIN, wireless, VoIP, etc.) on which the service is to operate. Based on the content of the web page, the service is then provisioned for the subscriber. Alternatively, the provisioning may be achieved by DTMF touch-tone options on the home or office telephone which enhanced call control service is provided. Additionally, an external access dial number may be available to allow a subscriber to remotely modify his/her call control options.

Provisioning refers to providing or making a service or facility available. In telecommunications terminology, provisioning means providing a product or service, such as wiring or bandwidth or more specifically, a call screening service which automatically processes incoming or outgoing calls for the subscriber. This includes providing telecommunications service to a user, including everything necessary to set up the service, such as equipment, wiring, and transmission.

The provisioned service is specified by two items, the telephone number 902 and an associated password 904. The telephone number 902 defines the communication station for which the service is provisioned. The communication station may be a land line telephone defined by a directory number or may be a wireless phone defined by a wireless telephone number, or may be an IP device defined by an IP address. Alternatively any other identifier may be used. The password 904 is used to provide secure access to the subscriber.

In the illustrated embodiment, general provisioning options include (1) Change/Set PIN and (2) Change/Set email notification address. The PIN is the identifier used to override the service when a call is subject to the screening service.

The provisioned service is further defined by two classes of data, outdialing restrictions 908 and incoming restrictions 910. In accordance with the embodiment of FIG. 9, the incoming restrictions 908 and outbound restrictions 910 are separately configurable for ultimate flexibility for the subscriber.

In the illustrated example, provisioning for outbound calling includes but not be limited to Restrictions ON/OFF 912; Restrict all outbound long distance 914; Restrict all outbound dialing 916; Restrict individual outbound numbers from being dialed 918, with Unlimited entries 920; Allow list (restrict all but these) outbound 922, with Unlimited entries 924; Time of day restrictions for outbound dialing 926; and Day of week restrictions for outbound dialing 928.

The Restrictions ON/OFF 912 is a binary value corresponding to whether the service is active, or turned ON, or inactive and turned OFF. The Restrict all outbound long distance 914 defines whether calls outside the local dialing area are to be permitted or blocked. Restrict all outbound dialing 916 defines whether any outbound calls may be made from the calling communication station. Restrict individual outbound numbers from being dialed 918 specifies that all calls to directory numbers on a list of one or more numbers, stored in the Unlimited entry blocks 920, are to be blocked. When a call is placed from the calling communication station, the status of the Restrict individual outbound numbers from being dialed 918 element is determined, for example, by the SCP or SN/IP processing the call. If the feature is active, the dialed directory number is compared with the list of numbers stored in the Unlimited entry blocks 920. If a match is found, the call is blocked by the service.

Similarly, the item Allow list (restrict all but these) outbound 922 specifies that all outgoing calls are permitted except calls to number on the list stored in the Unlimited entries 924. Time of day restrictions for outbound dialing 926 specify a schedule of times during the day or days of the week when calls should be blocked. Similarly, Day of week restrictions for outbound dialing 928 specify a schedule of days when calls should be blocked. When a call is being processed, the current time and day information is compared with the contents of items 926 and 928 and the call is blocked or completed accordingly.

Further in this example, provisioning for incoming calls include Restrictions ON/OFF 930; Restrict all incoming calls 932; Restrict individual incoming calls 934, with Unlimited entries 936; Allow list (restrict all but these) incoming calls 938, with Unlimited entries 940; Time of day restrictions for incoming calls 942; and Day of week restrictions for incoming calls. The restrictions specified for incoming calls are defined similarly to those for outgoing calls, as described above.

For this example, all call restrictions for outbound dialing and incoming calls are based upon the entries and options defined by the subscriber from the format of FIG. 9. These options are stored within a database on the AIN SN/IP or any other convenient location and determine ultimate call routing capabilities. Also in accordance with this embodiment, at no time is emergency or 911 outbound dialing restricted.

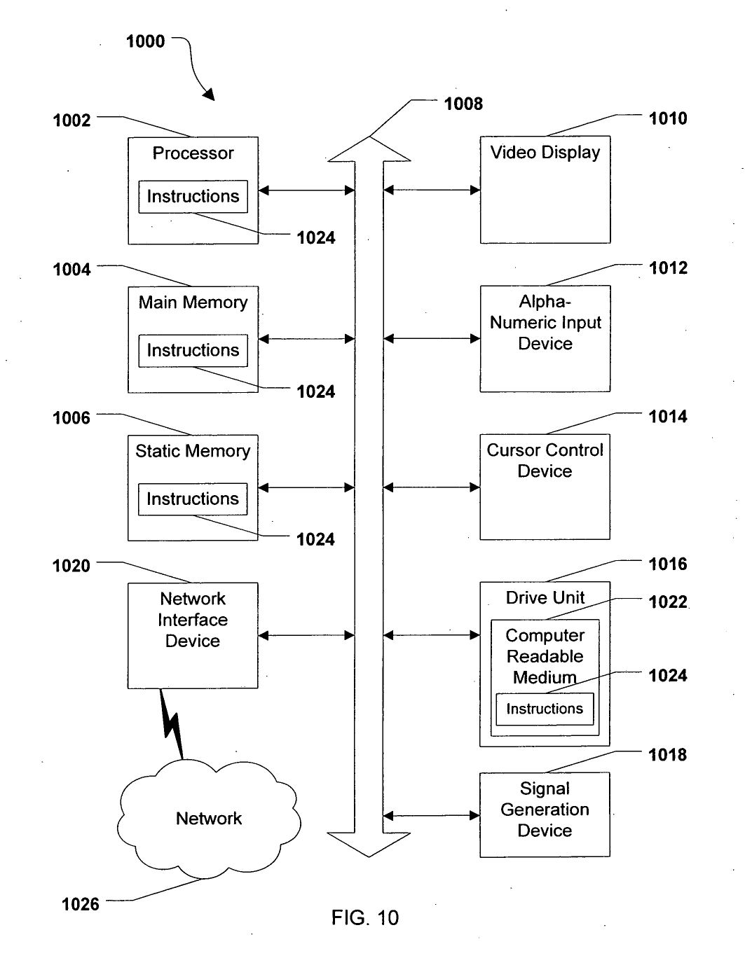

Referring to FIG. 10, an illustrative embodiment of a general computer system is shown and is designated 1000. The components illustrated in FIGS. 1, 2 3 and 4 can be implemented as one or more general computer system such as the computer system 1000. The computer system 1000 can include a set of instructions that can be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. Moreover, the computer system 1000 can include a main memory 1004 and a static memory 1006 that can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. The computer system 1000 can also include a disk drive unit 1016, a signal generation device 1018, such as a speaker or remote control, and a network interface device 1020.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

The present embodiments provide systems and methods for efficiently and effectively screening calls. The present embodiments allow for a user to select parameters for screening incoming and/or outgoing calls that are made to and/or from different communication devices and that are made using different types of communication networks. The user station is able to provide identifiers for call sources and/or destinations that can be used in the systems and methods to determine related identifiers for the call sources and/or destinations so that all calls to or from the sources and/or destinations can be effectively screened. The system and methods also provide for the user to be notified of the number of calls, types of calls, etc. that have been screened. This enables the user to determine the source and/or intended recipient of the screened calls, as well as the frequency of the attempted unauthorized calls.

We claim:

1. A method for screening calls, the method comprising
(a) receiving information from a user that specifies the user's preferences for screening certain types of calls;
(b) screening a call based upon the information received from the user; and
(c) notifying the user that the call was screened.

2. The method of claim 1, wherein (a) comprises receiving information transmitted by the user via a computer.

3. The method of claim 1, wherein (a) comprises receiving information that specifies a telephone number from which incoming calls will be screened.

4. The method of claim 1, wherein (a) comprises receiving information that specifies an internet protocol address from which incoming calls will be screened.

5. The method of claim 1, wherein (a) comprises receiving information that specifies a telephone number to which outgoing calls are directed will be screened.

6. The method of claim 1, wherein (a) comprises receiving information that specifies an internet protocol address to which outgoing calls are directed will be screened.

7. The method of claim 1, wherein (a) comprises receiving information that specifies a time of day that one or more calls will be screened.

8. The method of claim 1, wherein (a) comprises receiving information that specifies a day of the week that one or more calls will be screened.

9. The method of claim 1, wherein (a) comprises receiving information that specifies a day of the year that one or more calls will be screened.

10. The method of claim 1, wherein (b) comprises screening an incoming call.

11. The method of claim 1, wherein (b) comprises screening an outgoing call.

12. The method of claim 1, wherein (b) comprises canceling the call.

13. The method of claim 1, wherein (b) comprises routing the call to voicemail.

14. The method of claim 1, wherein (b) comprises transmitting a message to a caller that initiated the call.

15. The method of claim 1, wherein (c) comprises transmitting a list of calls that were screened to the user via electronic mail.

16. The method of claim 1, wherein (c) comprises making a list of calls that were screened accessible to the user via a computer.

17. The method of claim 1, further comprising, prior to (a), providing a graphical user interface through which the user can provide the information that specifies the user's preferences for screening certain types of calls.

18. A method for screening incoming calls, the method comprising
(a) receiving a first identifier for one or more call sources for which a user is requesting call screening;
(b) storing the first identifier for the one or more call sources, a second identifier for the one or more call sources, and a call screening indicator that is associated with the first or second identifier for the one or more call sources, where the first and second identifiers for the one or more call sources are selected from the group consisting of a telephone number, an internet protocol (IP) address and a domain name;
(c) receiving an incoming call;
(d) determining an incoming call identifier for the incoming call;
(e) determining whether the incoming call identifier matches the first or second identifiers for the one or more call sources; and
(f) screening the call if the incoming call identifier matches the first or second identifiers for the one or more call sources.

19. The method of claim 18, wherein (d) comprises determining an originating telephone number for the incoming call.

20. The method of claim 18, wherein (d) comprises determining an originating internet protocol (IP) address for the incoming call.

21. The method of claim 18, wherein (f) comprises canceling the call.

22. The method of claim 18, wherein (f) comprises routing the call to voicemail.

23. The method of claim 18, wherein (f) comprises transmitting a message to a caller that initiated the incoming call.

24. The method of claim 18, further comprising notifying the user that the call was screened.

25. The method of claim 18, further comprising, prior to (a), providing a graphical user interface through which the user can provide the first identifier for the one or more call sources for which a user is requesting call screening.

26. The method of claim 18, further comprising receiving information from a user that specifies a time of day that an incoming call should be screened and wherein (f) comprises screening the call if the incoming call identifier matches the first or second identifiers for the call source and a current time of day matches the time of day specified by the user.

27. The method of claim 18, further comprising receiving information from a user that specifies a day of the week that an incoming call should be screened and wherein (e) comprises screening the call if the incoming call identifier matches the first or second identifiers for the one or more call sources and a current day of the week matches the day of the week specified by the user.

28. The method of claim 18, further comprising receiving information from a user that specifies a day of the year that an incoming call should be screened and wherein (f) comprises screening the call if the incoming call identifier matches the first or second identifiers for the one or more call sources and a current day of the year matches the day of the year specified by the user.

29. The method of claim 18, further comprising, prior to (f), notifying a caller that the call is subject to call screening and requesting that the call enter an override code, and wherein (f) comprises screening the call if the incoming call identifier matches the first or second identifiers for the call source and the caller fails to provide the override code.

30. A method for screening outgoing calls, the method comprising
(a) receiving a first identifier for a call destination for which a user is requesting call screening;
(b) storing the first identifier for the call destination, a second identifier for the call destination, and a call screening indicator that is associated with the first or second identifier for the call destination, where the first and second identifiers for the call destination are selected from the group consisting of a telephone number, an internet protocol (IP) address and a domain name;
(c) receiving an outgoing call;
(d) determining an outgoing call identifier for the outgoing call;
(e) determining whether the outgoing call identifier matches the first or second identifiers for the call destination; and
(f) screening the call if the outgoing call identifier matches the first or second identifiers for the call destination.

31. The method of claim 30, wherein (d) comprises determining a termination telephone number for the outgoing call.

32. The method of claim 30, wherein (d) comprises determining a termination internet protocol (IP) address for the outgoing call.

33. The method of claim 30, wherein (f) comprises canceling the call.

34. The method of claim 30, wherein (f) comprises transmitting a message to a caller that initiated the incoming call.

35. The method of claim 30, further comprising notifying the user that the call was screened.

36. The method of claim 30, further comprising, prior to (a), providing a graphical user interface through which the user can provide a plurality of identifiers including the first identifier for a call destination for which a user is requesting call screening.

37. The method of claim 30, further comprising receiving information from a user that specifies a time of day that an outgoing call should be screened and wherein (f) comprises screening the call if the outgoing call identifier matches the first or second identifiers for the call destination and a current time of day matches the time of day specified by the user.

38. The method of claim 30, further comprising receiving information from a user that specifies a day of the week that an outgoing call should be screened and wherein (f) comprises screening the call if the outgoing call identifier matches the first or second identifiers for the call destination and a current day of the week matches the day of the week specified by the user.

39. The method of claim 30, further comprising receiving information from a user that specifies a day of the year that an outgoing call should be screened and wherein (f) comprises screening the call if the outgoing call identifier matches the first or second identifiers for the call destination and a current day of the year matches the day of the year specified by the user.

40. The method of claim 30, further comprising, prior to (f), notifying a caller that the call is subject to call screening and requesting that the call enter an override code, and wherein (f) comprises screening the call if the outgoing call identifier matches the first or second identifiers for the call destination and the caller fails to provide the override code.
